(19) United States
(12) Patent Application Publication
(10) Pub. No.: US 2003/0033863 A1
(43) Pub. Date: Feb. 20, 2003

(54) Atomic force microscopy for high throughput analysis

(76) Inventors: Paul Ashby, Cambridge, MA (US); Scott Sternson, New York, NY (US); Angie You, San Francisco, CA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/215,408

(22) Filed: Aug. 8, 2002

Related U.S. Application Data
(60) Provisional application No. 60/310,993, filed on Aug. 8, 2001.
(60) Provisional application No. 60/323,191, filed on Sep. 18, 2001.

(51) Int. Cl. G01B 5/28

(52) U.S. Cl. 73/105

(57) ABSTRACT

An atomic force microscope may include a plurality of cantilevers, each cantilever comprising a tip, wherein for at least one tip, a z-control independently positions the at least one tip along a z-axis with respect to a surface. A method of high-throughput screening may include providing an atomic force microscope comprising a plurality of cantilevers, each cantilever comprising a tip, wherein for at least one tip, a z-control independently positions the at least one tip along a z-axis with respect to a surface, attaching a first test molecule to a preselected tip, attaching a second test molecule to the surface, generating a drive signal to oscillate each cantilever of the plurality of cantilevers, orienting the preselected tip and the surface relative to each other along the z-axis, detecting for each cantilever a response signal proportional to an oscillatory motion thereof, detecting a change in the response signal for each cantilever of the plurality of cantilevers, and determining from the change in the response signal whether binding has occurred between the first test molecule and the second test molecule.

### CROSS-REFERENCE TO RELATED APPLICATIONS

This application claims benefit of priority to U.S. Provisional Patent Application Serial No. 60/310,993, filed Aug. 8, 2001, and also claims benefit of priority to U.S. Provisional Patent Application Serial No. 60/323,191, filed Sep. 18, 2001. The entireties of the above-referenced provisional patent applications are hereby incorporated herein by this reference.

### BACKGROUND

The disclosed systems and methods relate generally to high throughput screening of interactions between various molecules, and, more particularly, to a multiple-probe atomic force microscope and method for high throughput measurement of binding interactions between small molecules and proteins.

Small molecules which are known to bind to certain proteins can be useful in the study of the function of a protein in a disease system or other biological system. Such a small molecule can be used to perturb a protein in a biological system, allowing the role of the protein in that system to be assessed. The small molecule can further be used to develop a drug that disrupts a disease system. Detecting interactions between candidate molecules is therefore a key component of both basic and applied biomolecular research. One technique for discovering such interactions employs an atomic force microscope (AFM) to detect interactions between molecules attached to a probe, and other molecules residing on a surface.

An AFM, shown schematically in one embodiment in FIG. 1, may include a sharp point (tip) brought near to or in contact with a surface. The forces between the tip and the surface may provide information about the physical, chemical or biological properties of the surface. The tip may include an attached substance to be tested for interactions with materials deposited on the surface. Measuring the interaction between the tip and the surface may then provide information about the interactions between the molecules under test. An example of this technology may be found in U.S. Pat. No. 5,763,768, which is incorporated herein by reference.

In this type of AFM, the tip is generally supported by an elastic member (most frequently, a cantilever) whose deflection is proportional to the applied force. The tip and surface are translated relative to each other to provide an image of surface features over an area of the surface. Deflection of the elastic member caused by the interaction of the tip with the surface is commonly measured using one of two configurations. The first, described in U.S. Pat. No. 5,763,768, uses a laser beam reflecting off the cantilever and a position-sensitive photodiode. As the cantilever twists or is deflected due to interactions between the tip and the surface, the resulting change in position of the reflected beam is detected by the position-sensitive photodiode. This detection method is shown schematically in FIG. 2a. The second detection method, described in detail in U.S. Pat. No. 5,345,815, which is incorporated herein by reference, uses a piezo-resistive coating on the elastic member. The resistance of the coating changes as interaction between the tip and the surface deflects or twists the cantilever. This detection method is shown schematically in FIG. 2b. In either scheme, deflection or twisting of the cantilever is converted to a detectable electric signal.

Several methods of AFM measurement have been developed since the original invention of the AFM. One method, termed “contact mode,” is described in U.S. Pat. No. 4,935,634, which is incorporated herein by reference. In contact mode, the tip is kept in contact with the surface at all times as the scanning is performed. Typically, deflection of the elastic member is held constant by a servo-loop controlling the height of the sample during scanning to provide a measurement of surface topography. In this method, the twisting of the elastic member is a measure of the changes in friction between the tip and the surface. Contact mode atomic force microscopy is elegant and simple, but the shear forces between the surface and sharp point are often too high for many soft and deformable samples such as biological molecules.

In part to avoid the potential damage to tip and surface that occurs in contact mode atomic force microscopy, the AFM can be operated by oscillating the elastic member during scanning. The oscillations may be excited by several methods. The most common embodiment uses a piezoelectric transducer (PZT) to excite the whole apparatus holding the elastic member. This configuration is shown schematically in FIG. 3a. Energy couples through the apparatus to the elastic member to establish a stable oscillation. This configuration is simple, but the coupling process can distort the resonant properties of the elastic member. This is especially evident in fluid where amplitude and phase response are determined by the coupling of the apparatus to the fluid and not by the tip interacting with the surface.

In a second configuration, shown schematically in FIG. 3b, the elastic member is excited by applying a magnetic coating to the elastic member, and driving oscillations using an oscillating magnetic field. In a third embodiment, described by S. C. Minne, et al., Applied Physics Letters 67, 3918, and shown schematically in FIG. 3c, micro-fabrication techniques can be used to place a PZT directly on the elastic member.

Once a stable resonance and/or oscillation has been excited in the elastic member, the attractive interactions between the tip and surface cause a measurable change to the elastic member's characteristic properties, such as the resonant frequency or the phase lag between the drive and the measured signal. These changes in resonant behavior may be mapped as the tip is scanned relative to the surface, without requiring actual contact between the tip and the surface.

In non-contact mode AFM, developed by Martin, et al. (J. Applied Physics, 61(10), May 15, 1987), interactions between the tip and the surface are identified by oscillating the elastic member over the surface and measuring perturbations to the oscillatory motion due to the attractive forces between the tip and the surface. The non-contact mode AFM is extremely sensitive but can be slow to operate. This is due to the fact that stable feedback is difficult to maintain, owing to the tendency of the tip to snap into contact with the surface. The non-contact AFM is also difficult to implement when the quality factor (Q) of the elastic member is too low, such as when the elastic member's oscillation is damped by surrounding fluid. Non-contact mode is therefore poorly suited for probing the interactions between small molecules and proteins, because proteins are preferably immersed in fluid in order to maintain their natural state, thereby effecting fluid immersion of the surface and the tip. Further, the slow operation of AFMs in non-contact mode makes it a poor choice for a high-throughput screening technique, in which a goal is to maximize the number of potential interactions that may be tested per unit time.

A third method of atomic force microscopy, sometimes known as tapping mode, is described in detail in U.S. Pat. No. Re. 36,488, which is incorporated herein by reference. In tapping mode, the tip is made repeatedly to contact the surface. Resonant oscillation is induced in the elastic member using the same techniques as in non-contact mode. Typically, the frequency is held constant, and interaction between the tip and the surface is detected as a decrease in oscillation amplitude or change in the phase difference between the drive and measured signals when the tip interacts with the hard-shell repulsive potential at the surface. The tapping mode AFM is commonly much faster, more stable, and more versatile than the non-contact AFM, while providing a comparable sensitivity and gentleness.

Due to the vast number of varieties of molecules that occur in biological systems and small molecule candidates, high throughput screening of potential binding interactions is desirable. A typical AFM containing only a single tip severely limits the number of interactions that can be screened per unit time. AFMs with multiple tips for simultaneously scanning multiple portions of a surface are known in the art (e.g. U.S. Pat. No. 5,047,633, which is incorporated herein by reference), but it is difficult to achieve precise positioning of each tip to ensure that it maintains the desired distance from the surface. Such precise positioning is important for compensating for irregularities in the surface, or in the manufacture or construction of the array of AFM tips. It is further understood that control of that distance in all modes of atomic force microscopy is important for determining the force applied to the sample in contact mode, and for arranging, in tapping and non-contact modes, whether the repulsive or attractive portion of the tip-surface potential is being sampled.

There remains a need in the art, therefore, for an AFM suitable for high throughput screening of potential molecular binding interactions when candidate molecules are immersed in fluid. In addition, when interaction times are too slow for traditional tapping mode to be used, such as single probe tapping mode, there is need for another method that can still achieve high throughput. Moreover, there is a further need for a multiple-tip AFM which can achieve precise positioning of each AFM tip as it is employed in the high throughput screening process.

### SUMMARY

In one aspect, the present disclosure describes an AFM for use in high throughput screening of potential interactions between biological molecules. In one embodiment, an apparatus is provided that samples the attractive portion of the tip-surface potential as in traditional non-contact mode, but functions with the tip and surface immersed in fluid, allowing protein systems to be probed in their natural state. In another aspect, the present disclosure describes a device permitting longer interaction times than traditional tapping mode, allowing for measurement of slower interactions between the molecules under test. In certain embodiments, systems and methods disclosed and/or contemplated herein incorporate multiple tips with independent control of the tip-surface distance, allowing accurate screening of multiple interactions simultaneously. In further aspects, systems and methods disclosed and/or contemplated herein provide a technique for high throughput screening of the interactions between substances under test. Certain embodiments include a method for high throughput measurement of binding energies between proteins and small molecules.

### BRIEF DESCRIPTION OF THE FIGURES

FIG. 1 is a schematic drawing of a prior art AFM.

FIGS. 2a-b are schematic drawings illustrating detection methods for atomic force microscopy known in the prior art.

FIGS. 3a-c are schematic drawings illustrating prior art methods used to excite oscillations of the elastic member.

FIGS. 4a-b are schematic drawings of prior art methods to scan tip and sample relative to each other.

FIGS. 5a-b are schematic drawings of one embodiment of a tip holder using a solenoid to drive the oscillation and/or resonance.

FIGS. 6a-b are schematic drawings of one embodiment of an AFM detection head.

FIG. 7 is a schematic drawing of one embodiment of a high throughput AFM assembly showing multiple detection heads arranged in array

FIG. 8 is a schematic drawing of one embodiment of the dual translation stage used to control the position of the sample.

FIG. 9 is a schematic drawing of a tip to which a test molecule is attached via a molecular tether.

FIG. 10 is a schematic drawing of an embodiment of the Q-enhancing feedback system.

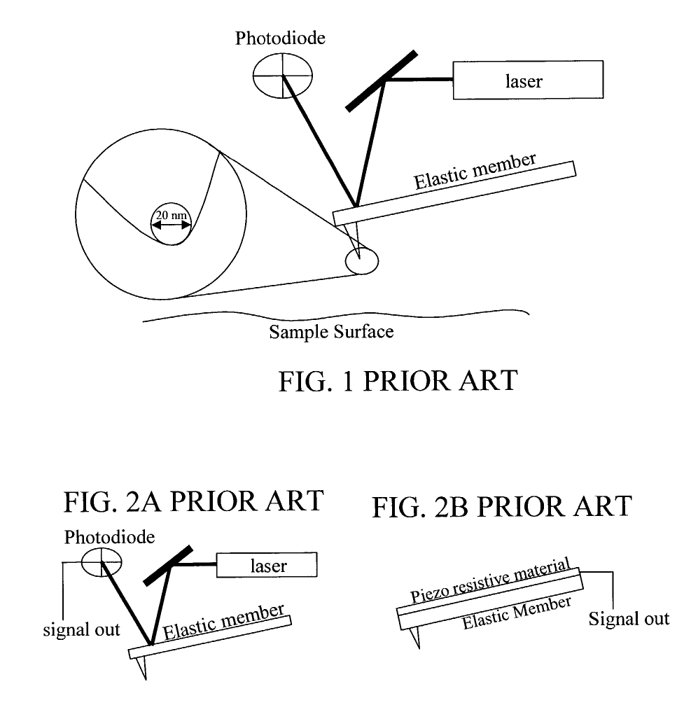

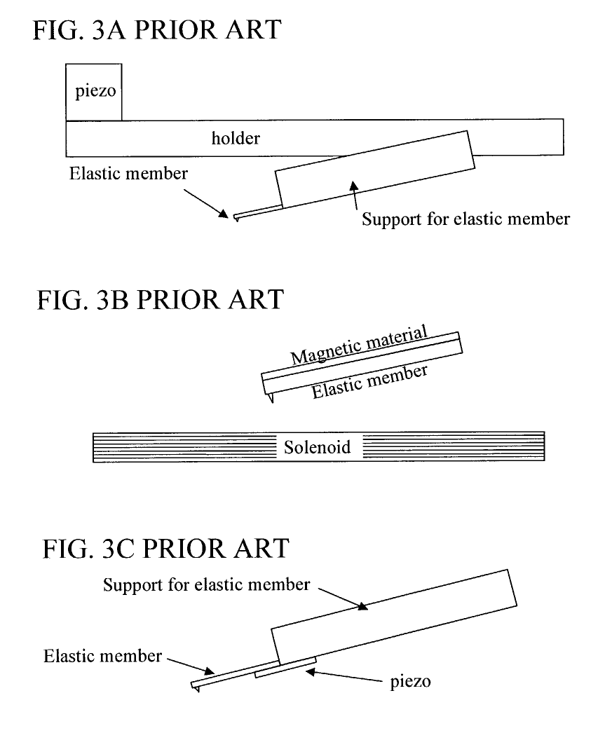

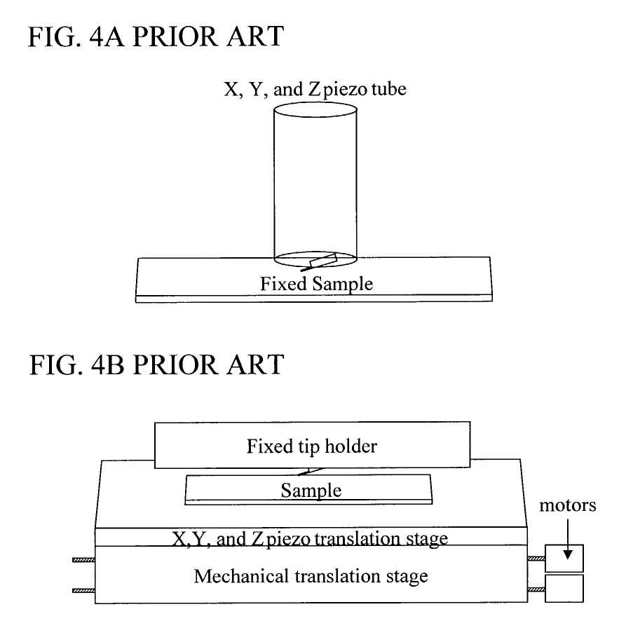

### DETAILED DESCRIPTION OF EXEMPLARY EMBODIMENTS

The following detailed description includes, but is not limited to, certain exemplary embodiments pictured in the figures. This description is not to be taken as limiting the scope of the disclosure, but merely illustrates the general principles of various embodiments. In the figures, like numbers refer to like items throughout. The figures are schematic illustrations, and may not be to scale. Dimensions are included only to illustrate examples and not to limit the embodiments.

A. Definitions

The terms “polynucleotide,” “oligonucleotide,” “nucleic acid” and “nucleic acid molecule” are used herein to include a polymeric form of nucleotides of any length, either ribonucleotides or deoxyribonucleotides. This term refers only to the primary structure of the molecule. Thus, the term includes triple-, double- and single-stranded DNA, as well as triple-, double- and single-stranded RNA. It also includes modifications, such as by methylation and/or by capping, and unmodified forms of the polynucleotide. More particularly, the terms “polynucleotide,” “oligonucleotide,” “nucleic acid” and “nucleic acid molecule” include polydeoxyribonucleotides (containing 2-deoxy-D-ribose), polyribonucleotides (containing D-ribose), any other type of polynucleotide which is an N- or C-glycoside of a purine or pyrimidine base, and other polymers containing nonnucleotidic backbones, for example, polyamide (e.g., peptide nucleic acids (PNAs)) and polymorpholino (commercially available from the Anti-Virals, Inc., Corvallis, Oreg., as Neugene) polymers, and other synthetic sequence-specific nucleic acid polymers providing that the polymers contain nucleobases in a configuration which allows for base pairing and base stacking, such as is found in DNA and RNA. There is no intended distinction in length between the terms “polynucleotide,” “oligonucleotide,” “nucleic acid” and “nucleic acid molecule,” and these terms will be used interchangeably. These terms refer only to the primary structure of the molecule. Thus, these terms include, for example, 3′-deoxy-2′,5′-DNA, oligodeoxyribonucleotide N3′P5′ phosphoramidates, 2′-O-alkyl-substituted RNA, double- and single-stranded DNA, as well as double- and single-stranded RNA, DNA:RNA hybrids, and hybrids between PNAs and DNA or RNA, and also include known types of modifications, for example, labels which are known in the art, methylation, “caps,” substitution of one or more of the naturally occurring nucleotides with an analog, intemucleotide modifications such as, for example, those with uncharged linkages (e.g., methyl phosphonates, phosphotriesters, phosphoramidates, carbamates, etc.), with negatively charged linkages (e.g., phosphorothioates, phosphorodithioates, etc.), and with positively charged linkages (e.g., aminoalklyphosphoramidates, aminoalkylphosphotriesters), those containing pendant moieties, such as, for example, proteins (including nucleases, toxins, antibodies, signal peptides, poly-L-lysine, etc.), those with intercalators (e.g., acridine, psoralen, etc.), those containing chelators (e.g., metals, radioactive metals, boron, oxidative metals, etc.), those containing alkylators, those with modified linkages (e.g., alpha anomeric nucleic acids, etc.), as well as unmodified forms of the polynucleotide or oligonucleotide. In particular, DNA is deoxyribonucleic acid.

The term “aptamer” (or nucleic acid antibody) is used herein to refer to a single- or double-stranded DNA or a single-stranded RNA molecule that recognizes and binds to a desired target molecule by virtue of its shape. See, e.g., PCT Publication Nos. WO92/14843, WO91/19813, and WO92/05285, the disclosures of which are incorporated by reference herein.

“Polypeptide” and “protein” are used interchangeably herein and include a molecular chain of amino acids linked through peptide bonds. The terms do not refer to a specific length of the product. Thus, “peptides,” “oligopeptides,” and “proteins” are included within the definition of polypeptide. The terms include post-translational modifications of the polypeptide, for example, glycosylations, acetylations, phosphorylations and the like. In addition, protein fragments, analogs, mutated or variant proteins, fusion proteins and the like are included within the meaning of polypeptide.

The term “transmembrane protein” refers to a protein or protein subunit in which the polypeptide chain is exposed on both sides of the membrane. Transmembrane proteins include integral membrane proteins. Exemplary transmembrane proteins include α-helical proteins, e.g. bactiorhodopsin, and β-barrel proteins, e.g. outer membrane protein A (OmpA), FhuA, and FepA.

The term “antibody” as used herein includes antibodies obtained from both polyclonal and monoclonal preparations, as well as, the following: hybrid (chimeric) antibody molecules (see, for example, Winter et al. (1991) Nature 349:293-299; and U.S. Pat. No. 4,816,567); F(ab′)2 and F(ab) fragments; Fv molecules (noncovalent heterodimers, see, for example, Inbar et al. (1972) Proc Natl Acad Sci USA 69:2659-2662; and Ehrlich et al. (1980) Biochem 19:4091-4096); single-chain Fv molecules (sFv) (see, for example, Huston et al. (1988) Proc Natl Acad Sci USA 85:5879-5883); dimeric and trimeric antibody fragment constructs; minibodies (see, e.g., Pack et al. (1992) Biochem 31:1579-1584; Cumber et al. (1992) J Immunology 149B:120-126); humanized antibody molecules (see, for example, Riechmann et al. (1988) Nature 332:323-327; Verhoeyan et al. (1988) Science 239:1534-1536; and U.K. Patent Publication No. GB 2,276,169, published Sep. 21, 1994); and, any functional fragments obtained from such molecules, wherein such fragments retain specific-binding properties of the parent antibody molecule.

As used herein, a “biological sample” refers to a sample of isolated cells, tissue or fluid, including but not limited to, for example, plasma, serum, spinal fluid, semen, lymph fluid, the external sections of the skin, respiratory, intestinal, and genitourinary tracts, tears, saliva, milk, blood cells, tumors, organs, connective tissue and also samples of in vitro cell culture constituents of the aforesaid cells, tissue or fluid (including but not limited to conditioned medium resulting from the growth of cells in cell culture medium, putatively virally infected cells, recombinant cells, and cell components).

A “biomolecule” is a synthetic or naturally occurring molecule, such as a protein, amino acid, nucleic acid, nucleotide, carbohydrate, sugar, lipid and the like.

B. Device

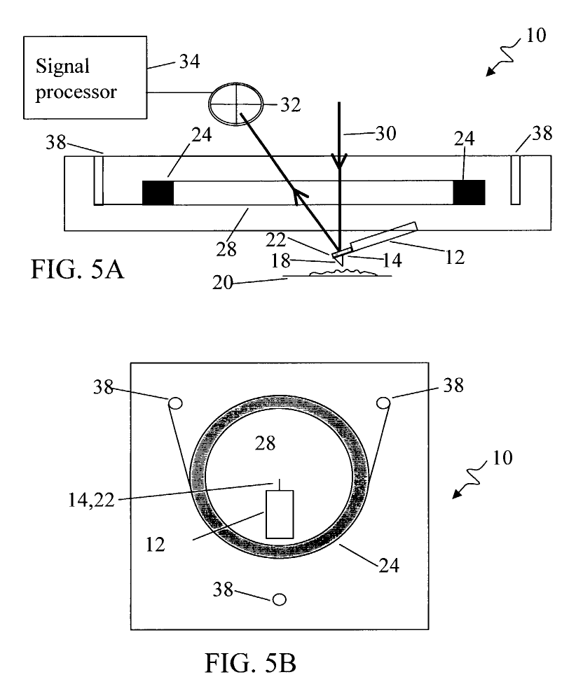

In one aspect, a purpose of the disclosed systems and methods is to provide high throughput analysis of the properties of materials. This may be achieved by the creation of a novel AFM composed of many elastic members working in parallel to analyze the surface. FIGS. 5-8 illustrate an embodiment of a novel AFM.

In an illustrative embodiment, the AFM includes at least one probe holder 10 as illustrated schematically in FIG. 5. FIG. 5a illustrates a side view of a probe holder, and FIG. 5b a top view. The probe holder carries a probe 12 comprising an elastic member (cantilever) 14 and a tip 18 configured to operate in an enhanced Q non-contact mode. The motion of the cantilever may be measured using one of the detection techniques described above. In an illustrative embodiment, a technique using a laser beam 30 and position sensitive photodetector 32 (not shown in the top view of FIG. 5b) is employed. The signal measured at the position sensitive photodetector may be processed or recorded by a signal processor 34.

Using one of the methods known in the art and described above, the cantilever may be made to oscillate at a distance above the surface at which the attractive portion of the tip-surface potential is sampled. In an embodiment illustrated schematically in FIG. 5, the cantilever 14 includes a layer 22 of a magnetic material such as cobalt. The probe 12 is housed in a support structure which includes a solenoid 24 to magnetically drive the oscillations. The solenoid 24 may be wound on a transparent core 28, which allows traversal of the laser beam 30 for optical detection of the probe position as described above. The probe holder may further comprise holes 38, which serve both as receptacles for support structures to mount the probe holder to the AFM apparatus, as well as electrical feedthroughs for the solenoid and any other electrical signal that may be sent to or retrieved from the probe holder assembly.

In a preferred embodiment, interaction between the probe tip 18 and the surface 20 may be detected as changes in the resonant properties of the oscillating cantilever due to the presence of the interaction. In a preferred embodiment, the interaction induces a phase shift between the cantilever drive signal and the response signal that is measured at the signal processor 34, which may comprise a lock-in amplifier or other detection electronics known in the art. In alternative embodiments, changes in other resonant properties of the cantilever, including without limitation frequency and amplitude, may be used to detect interactions between the tip and the surface. In other embodiments, the interactions may be measured using such signals as the height of the probe (measured as a voltage on the positioning piezo), deflection of the cantilever (its mean position relative to the equilibrium position), or friction (twisting of the cantilever caused by adhesion between the tip and surface in contact mode).

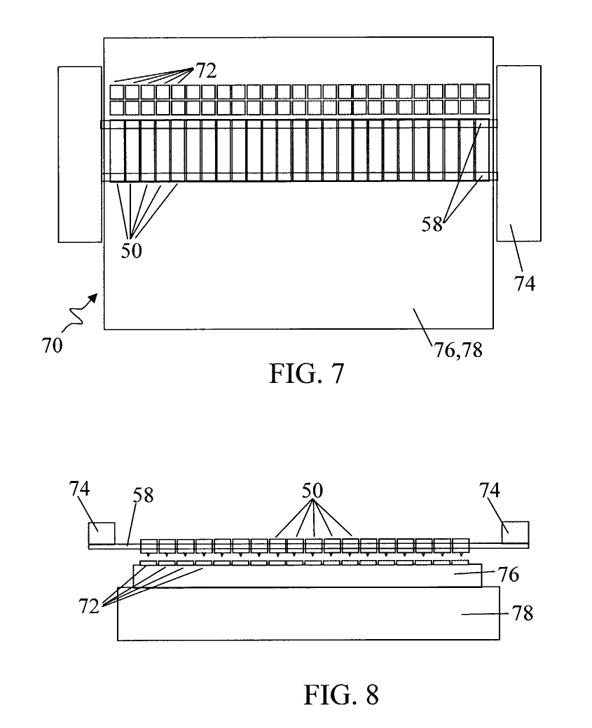

In certain embodiments, the surface 20 may contain proteins, small molecules, biomolecules, or other molecules whose interactions with test substances it may be desirable to investigate. In an illustrative embodiment, the proteins or other molecules to be tested may be deposited in an array pattern on a surface made of silicon, glass, plastic, metal, or other suitable material. The surface may be chemically functionalized to allow for covalent or non-covalent interaction with the molecules. The array pattern on the surface may include a plurality of sample areas, to each of which may be bound one or more proteins or molecules to be tested. In one embodiment, the surface may include a plurality of sample areas arranged in a row or an array, as illustrated schematically in FIG. 7. Each sample area 72 may contain its own array of test molecules bound to the surface. In one embodiment, each sample area 72 is approximately 3 mm by 3 mm in size, and contains an array of approximately 10,000 compounds.

In another embodiment, the biological or other molecules are deposited or encapsulated in an artificial membrane or colloidal dispersion system. Colloidal dispersion systems include macromolecule complexes, nanocapsules, microspheres, beads, and lipid based systems including oil-in-water emulsions, micelles, mixed micelles and liposomes. Liposomes are artificial membrane vesicles. Other artificial membranes include bilayer systems comprising liposomes. In a further embodiment, the biological molecules deposited in an artificial membrane are transmembrane proteins, receptors, channel-forming proteins, and ion-transporting proteins. In an even further embodiment, an electrical field or current may be applied to the artificial membrane which may change or set the orientation of a transmembrane protein.

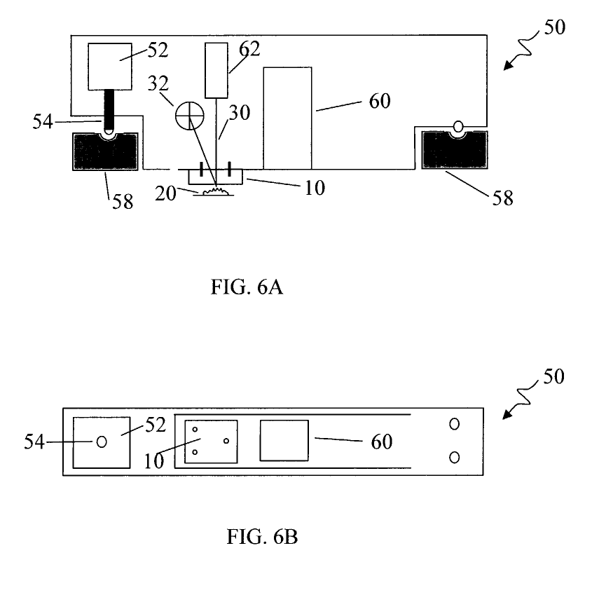

The probe holder 10 may be mounted via holes 38 to an AFM head. An AFM head according to an embodiment is illustrated schematically in FIG. 6. The AFM head 50 may rest on rails 58 allowing it to be positioned over a sample surface 20. The head may include an engagement motor 52 to achieve rough vertical (z-axis) positioning of the probe relative to the surface. This engagement motor may operate via an actuator 54 to raise or lower the probe. In another embodiment, a piezo element or other micropositioner may be used in addition to or in place of the engagement motor 52 and actuator 54. The AFM head 50 further comprises a fine z-axis positioning element 60, which may be a piezo element. In a preferred embodiment, an actuator 54 with an accuracy of about 20 nm to 1 μm, and a maximum travel range of about 200 μm to 10 cm serves as the coarse z-axis position control. Desirably, the coarse control may have an accuracy of about 100 nm, and a range of about 1 cm. In certain embodiments, a piezo element 60 with an accuracy of about 0.01 nm to 5 nm, and a maximum travel range of about 500 nm to about 10 μm, serves as the fine z-axis position control. Desirably, the fine control may have an accuracy of about 0.03 nm, and a range of about 2 μm.

In one embodiment, the AFM includes a plurality of AFM heads 50. FIG. 7 illustrates schematically an AFM with a plurality of heads according to an embodiment. As shown in FIG. 7, AFM heads 50 may be arranged along a straight line, supported by a support structure 64 and rails 58. The entire array as a whole may be translatable horizontally and vertically relative to the sample areas 72. In a preferred embodiment the spacing of sample areas 72 on the surface approximately equals the spacing between the multiple AFM probes, so that a plurality of binding interactions may be measured simultaneously. The surface is brought into alignment with the probes as described below, and interactions between each probe and the contents of each sample area in one row of the sample array are detected. Then the relative position of the probes and surface is translated so that the next row of sample areas in the array pattern may be studied. This is one way in which the disclosed systems and methods may achieve high throughout screening of interactions. Alternatively, the heads may be arranged in a two dimensional array. In yet another alternative embodiment, the heads may be incorporated onto a single chip, using etching or deposition techniques to manufacture the separate cantilevers and piezo elements for independent z-axis position control.

Either the AFM probe array, the individual probes, the surface, or a combination of the above may have independent means for position control. In one illustrative embodiment the surface may be fixed while the probe may be translated in the x, y, and z directions using a piezo tube actuator. In another embodiment, the surface may be scanned underneath the top array. The surface may have a positioning mechanism that employs at least two stages. An illustrative embodiment is shown schematically in FIG. 8. The first stage 78 may use motors, micropositioners, or piezo elements for positioning the sample in the x, y, and θ axes. A separately executed positioning of the surface may be performed in the z and φ axes to bring the surface into equal contact with each tip. Desirably, the first stage positioners may have an accuracy order of 1 μm (for x, y, and z) and one arcminute (for θ and φ), and a range on order of one cm (for x, y, and z) and 1 degree (for θ and φ). In certain embodiments, a second stage 76 of the positioning mechanism may use piezo mechanical devices for scanning the surface in the x and y axes, with accuracy on order of 10 mm, and a range on order of 1 mm.

In an embodiment, a surface containing an array of sample areas may be brought into alignment as follows. All the heads may be backed up to a predetemined point and then advanced to the same point using the actuators 54. The surface may then be stepped towards the array by a fixed interval (approximately 1 μm in one embodiment). The heads may then be moved toward the surface using fine control elements, piezo actuators 60, by a distance approximately equal to or somewhat greater than the interval. During this motion of the heads, the oscillation amplitude or frequency, or the deflection of each cantilever may be monitored, so that if one or more tips interacts with the surface it is detected. If no interaction is detected, the heads may be backed away from the surface. Then the surface may again be stepped by the interval, and the heads may again be moved toward the surface. This process may be repeated until an interaction is detected by one or more of the probes. In some embodiments, a feedback loop may then be activated to keep that probe which is detecting interaction at a fixed z-axis distance, using the piezo element 60 on that head, while the θ and φ angles of the surface are adjusted using the stages 78 or 76 until the remaining heads in the array detect interactions and are similarly controlled by their own feedback loops. In an embodiment, the roughness of the surface, the error in the machining, and/or a combination of both can be greater than 1 μm. In such a case, the engagement procedure can be facilitated by each unengaged probe being lowered using its own course adjustment mechanism. This may be done, for example, by the same or similar step-test method for engaging the first probes. In one embodiment, a single piezo element may control the z-axis position of the entire array. In other embodiments, each head's z-axis position is controlled by a separate piezo element. One advantage of independent control is that is allows compensation for any irregularities which may exist in the surface on in the manufacture or construction of the probe array itself.

The probe may be prepared to include a test substance attached, adhered, adsorbed, tethered, or bonded to the tip. Many methods for attaching test molecules to an AFM tip are known in the art, such as those described in U.S. Pat. No. 5,763,768. These test molecules may include, without limitation, ionophores, cofactors, polypeptides, proteins, polysaccarides, aptamers, polymerase chain reaction primers, glycoproteins, small molecules, enzymes, immunoglobulins, fusion proteins, antibodies, antigens, lectins, neurochemical receptors, oligonucleotides, molecules of DNA, molecules of RNA, the active fragments or subunits or single strands of the preceding molecules or mixtures thereof. The test molecules may include biological or other molecules deposited in an artificial membrane or colloidal dispersion system. Exemplary artificial membranes and colloidal dispersion systems are outlined above. In a further embodiment, the biological molecules deposited in an artificial membrane are transmembrane proteins. In an even further embodiment, an electrical field or current or any other type of electromagnetic radiation may be applied to the artificial membrane which may change or set the orientation of the protein. The AFM probes may be composed of, without limitation, silicon, silicon oxide, silicon nitride, gold, silver, aluminum, platinum, titanium dioxide, tin dioxide, or ruthenium dioxide. These functionalized probes may be used to measure the binding affinity between the biomolecule on the probe and chemical or biochemical molecules of interest in the sample array.

In some embodiments, the AFM may be employed not only to detect whether an interaction has occurred between the molecules bound to the tip and those on the surface, but also the particular binding energy of that interaction. Using the change in the cantilever resonance properties when binding and unbinding occur during cantilever oscillations, the binding affinity of the complex can be measured. This measurement may be calibrated by using molecules with known binding affinities on the tip and surface.

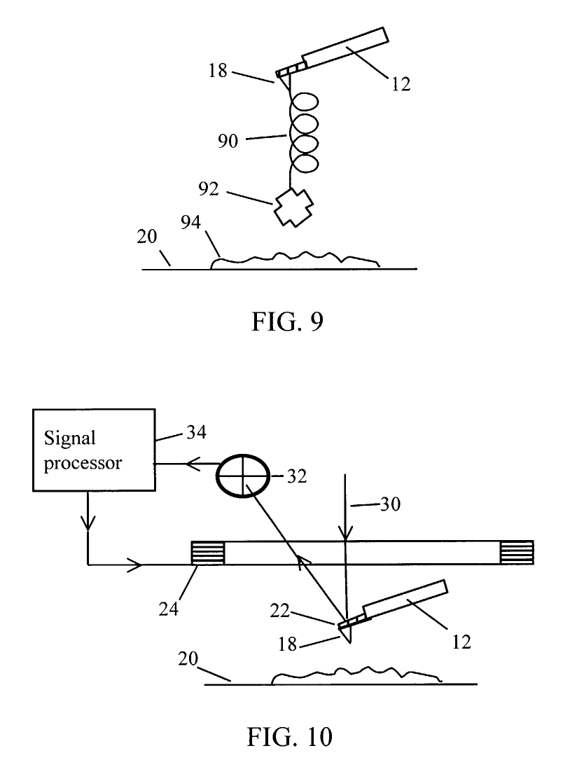

In one embodiment, illustrated schematically in FIG. 9, a molecular tether 90 may be interposed between the tip 18 and the test molecule 92. In one embodiment, the tether may be a polyethylene glycol chain of length approximately 2 nm. The tether 90 may be attached or bonded at one end to the AFM tip 18, and at the other end to the desired test molecule 92. In a device according to this embodiment, the probe 12 may be made to oscillate above the surface 20 as described above. If the test molecule at the end of the tether binds with material 94 on the surface, the oscillation will stretch and relax the tether, resulting in a loss of oscillation energy through the tether. This energy loss may be detected in the tip as a change in the probe's resonant properties, measured as discussed above as a change in frequency or amplitude of oscillation, or as a phase shift between the drive and response of the probe. An advantage of the use of a tether is an amplitude of oscillation smaller than the tether is detectable. Using a small amplitude allows the test molecule to remain for an extended period within a distance from the surface at which interaction may occur. A device operating according to this embodiment may be employed to detect interactions occurring on a relatively long time scale compared to the period of the cantilever oscillation.

An embodiment employing a tether to connect a test molecule to a tip may also be used with larger amplitude of oscillation, on the order of the tether length. In this embodiment, the test molecule is pulled in an out of the binding pocket on the material deposited on the surface. The tether may still allow the test molecule freedom to rotate and bind with the material. Interactions are detected as changes in the resonant properties of the probe as the tether stretches and pulls the test molecule out of the binding pocket, in some embodiments repeatedly stretching and pulling.

Because the proteins under test are desired in their natural state, the surface containing the proteins under test must be immersed in water or a buffer solution. The immersion of the probe in this solution damps its oscillation, lowering the quality factor (Q) of the probe resonance. The lower Q can increase the propensity for the oscillations to probe the repulsive portion of the probe surface potential. Energy dissipation caused by physical processes in the repulsive regime can obscure the signal of interest. Having the oscillation only sample the attractive portion of the probe-surface potential is advantageous. Therefore an enhanced Q is desirable. There are several schemes by which a disclosed device or method may achieve an enhanced probe resonance Q. In one embodiment, feedback from the probe signal is added to the probe drive. An embodiment employing such feedback is illustrated in FIG. 10, where the oscillations of the probe 12 are driven by a solenoid 24 which couples magnetically to a coating 22 on the probe as described previously. In this embodiment the signal processor 34 may amplify and phase shift the signal from the position sensitive photodiode 32, and use the resulting signal to drive the solenoid 24.

The motion of the probe oscillation may be represented by the following equation:

F_{d} sin(ωt)=m\ddot{x}+R\dot{x}+kx,

where x is the probe position (a function of time); \dot{x} and \ddot{x} are the first and second time derivatives of the position, respectively; k is the effective spring constant of the probe; R is the damping; m is the probe mass; and F_{d} represents the amplitude of the oscillation drive. The quality factor Q is given by:

$$Q = \sqrt{\frac{k m}{R}} .$$

If feedback from the position signal is shifted in phase by 90 degrees, it is proportional to \dot{x}, since x is a harmonic function. Added to the left side of the equation, this feedback thus alters the effective value of R, and can therefore be used to enhance or depress Q depending on whether the phase shift is +90 degrees or −90 degrees.

In another embodiment, enhanced Q is achieved by using a very stiff spring unlike traditional AFM cantilevers, so that the spring constant is relatively very high. In one embodiment a quartz tuning fork is piezo electric and can therefore serve as its own drive and its own position detector, while providing a very large Q.

While the description above refers to particular exemplary embodiments, it will be understood that many modifications may be made without departing from the spirit thereof. The accompanying claims are intended to cover such modifications as would fall within the scope and spirit of the disclosed systems and methods. Accordingly, only the following claims are intended to be limiting.

What is claimed is:

1. An atomic force microscope comprising a plurality of cantilevers, each cantilever comprising a tip, wherein for at least one tip, a z-control independently positions the at least one tip along a z-axis with respect to a surface.

2. The atomic force microscope of claim 1, wherein the plurality of cantilevers is arranged in an array.

3. The atomic force microscope of claim 1, wherein a first test molecule is attached to a first tip.

4. The atomic force microscope of claim 3, wherein a second test molecule is attached to a second tip.

5. The atomic force microscope of claim 1, wherein for each tip, a test molecule is attached thereto.

6. The atomic force microscope of claim 1, wherein the z-control comprises a rough control and a fine control.

7. The atomic force microscope of claim 1, wherein at least one test molecule is attached to the surface.

8. The atomic force microscope of claim 1, further comprising at least one positioning stage for controlling at least one position selected from the group consisting of: a first position of the surface along an x-axis, a second position of the surface along a y-axis, a third position of the surface along a z-axis, a fourth position of the surface about a θ-axis, and a fifth position of the surface about a φ-axis.

9. The atomic force microscope of claim 1, further comprising a solenoid that can magnetically couple to a coating on the at least one tip to drive an oscillation in the at least one tip.

10. The atomic force microscope of claim 9, wherein the solenoid is wound on a transparent core.

11. The atomic force microscope of claim 9, further comprising a signal processor that drives the solenoid.

12. The atomic force microscope of claim 11, wherein the signal processor receives a probe signal and drives the solenoid in response to the position signal.

13. A method of high-throughput screening, comprising
providing an atomic force microscope comprising a plurality of cantilevers, each cantilever comprising a tip, wherein for at least one tip, a z-control independently positions the at least one tip along a z-axis with respect to a surface;
attaching a first test molecule to a preselected tip;
attaching a second test molecule to the surface;
generating a drive signal to oscillate each cantilever of the plurality of cantilevers;
orienting the preselected tip and the surface relative to each other along the z-axis;
detecting for each cantilever a response signal proportional to an oscillatory motion thereof;
detecting a change in the response signal for each cantilever of the plurality of cantilevers; and
determining from the change in the response signal whether binding has occurred between the first test molecule and the second test molecule.

14. The method of claim 13, further comprising determining from the change in the response signal a binding affinity between the first test molecule and the second test molecule.

15. The method of claim 13, wherein the atomic force microscope further comprises at least one positioning stage for controlling at least one position selected from the group consisting of: a first position of the surface along an x-axis, a second position of the surface along a y-axis, a third position of the surface along a z-axis, a fourth position of the surface about a θ-axis, and a fifth position of the surface about a φ-axis.

16. The method of claim 15, wherein the plurality of cantilevers is arranged in an array.

17. The method of claim 16, further comprising the step of using the at least one positioning stage to orient the surface in a desired configuration relative to the array.

18. The method of claim 13, further comprising generating an amplified response signal by amplifying the signal from a preselected cantilever, and adding the amplified response signal to the drive signal for oscillating the preselected cantilever.

19. The method of claim 13, further comprising generating a phase shifted response signal by phase shifting the signal from a preselected cantilever, and adding the phase shifted response signal to the drive signal for oscillating the preselected cantilever.

20. A high-throughput screening system, comprising:
an atomic force microscope having an array of tips;
a surface having an array of samples to be tested; and
means for measuring an interaction between one of the array of tips and one of the array of samples to be tested.
